(19) United States
(12) Patent Application Publication
(10) Pub. No.: US 2016/0001372 A1
(43) Pub. Date: Jan. 7, 2016

(54) MACHINING PROCESS OF PINION SHAFTS ON LATHES

(71) Applicant: MAG IAS GMBH, Göppingen (DE)

(72) Inventors: Leo Schreiber, Schwäbisch Gmünd (DE); Albrecht Hannig, Eislingen (DE); Werner Mühlich, Süssen (DE)

(21) Appl. No.: 14/654,294

(22) PCT Filed: Dec. 13, 2013
(86) PCT No.: PCT/EP2013/076554

§ 371 Date: Sep. 18, 2015

(30) Foreign Application Priority Data
Dec. 21, 2012 (DE) 10 2012 113 022.1

(51) Int. Cl. B23B 3/16; F16D 3/40; B23P 23/02; B23B 5/00; B23Q 39/02

(52) U.S. Cl. CPC B23B 3/168; B23B 5/00; B23Q 39/026; B23P 23/02; F16D 3/40; B23Q 2039/008

(57) ABSTRACT

Instead of receiving universal joint crosses (1) like in the prior art in a special chuck of a turning machine and machining one respective pinion (2) and subsequently cycling the work piece by 90°, a contact surface (18) with a clamping device (19) is provided in the operating area according to the invention, wherein the raw part can be placed on the clamping device and can be clamped so that two opposite faces can be machined in this first clamping step including machining centering boreholes, wherein clamping is performed thereafter between centering points (22) at the centering boreholes for machining the adjacent enveloping surfaces.

After a cycling by 90° on this contact surface (18) the same steps are performed for the second pair of pinions, wherein machining the aligned pinions (2) can even he performed simultaneously if the machinery is configured accordingly.

### I. FIELD OF THE INVENTION

The invention relates to a manufacturing method and a suitable machine for producing universal joint crosses and similar work pieces which include rotation symmetrical portions whose rotation axes are arranged at an angle, in particular at a right angle relative to each other.

### II. BACKGROUND OF THE INVENTION

For the purposes of describing the instant invention, the term “universal joint crosses” is used exclusively to describe the work pieces recited supra.

In universal joint crosses of this type, the end portions have to be machined at their enveloping surfaces and faces, whereas a center portion typically remains raw as it comes from the primary forming process (casting or forging).

In the past, universal joint crosses of this type were machined on turning machines by clamping them in a special chuck so that only one respective pinion of the universal joint cross protruded from the chuck and could be machined with the work piece driven to rotate about its rotation axis.

Subsequently, the universal joint cross was cycled forward by 90° about a cycle axis that is arranged transversal to the rotation axis and the next pinion was machined through turning.

Long machining time was a disadvantage of this method since the four pinions had to be machined in sequence.

The complex special chuck that was required was another disadvantage since the chuck was not only expensive but also large and voluminous and gains weight and size over proportionally with increasing size of the universal joint crosses which made the masses driven in rotation very large and depending on the size of the machine that was being used only relatively small universal joint crosses could be machined.

It is another disadvantage that cycle imprecisions have occurred through the respective cycling by 90° for each individual pinion.

### III. DETAILED DESCRIPTION OF THE INVENTION

### a) Technical Task

Thus, it is an object of the invention to provide a machining method for universal joint crosses and other work pieces which provides a short machining time and requires less complicated accessories and which facilitates machining larger universal joint crosses in the same machine. The required machine or device shall be configured simpler and more cost-effective.

### b) Solution

The object is achieved by the features of claims 1 and 7. Advantageous embodiments can be derived from the dependent claims.

The solution with respect to the method is using a different clamping arrangement at the raw component and machining an aligned pair of rotation symmetrical sections at the work piece in one clamping step which reduces machining time and on the other hand minimizes errors created by repeated clamping.

Namely in the first clamping step, the work piece is clamped in its center portion at surfaces that are typically not yet machined so that two aligned rotation symmetrical sections can be machined in this clamping step, thus the two faces that are oriented parallel to one another can be machined. This typically includes machining the faces, thus machining the work piece to length from one face to another and introducing center boreholes into the faces.

Subsequently, the work piece is pivoted about a pivot axis which is oriented perpendicular to the connection line between the centering boreholes that have already been fabricated and wherein the pivot axis is also perpendicular to the centering boreholes still to be fabricated for the two other rotation symmetrical sections and in this pivoted position in turn the other rotation symmetrical sections that are aligned with one another are machined as described supra by machining the faces, thus machining the work piece to length from one face to another face and introducing centering boreholes into the faces.

This step can also be performed later, namely after the first pair of pinions was machined to a finished condition.

In this clamping step the work piece is advantageously parallel to the rotation axis of the turning machine with a rotation axis of the rotation symmetrical sections to be machined in this step or on the rotation axis of the turning machine.

Subsequently the work piece is clamped between two centering points which engage the prefabricated centering boreholes and the clamping in its center portion at surfaces that are typically not yet machined is disengaged. The work piece is additionally driven in rotation and enveloping surfaces of the first pair of pinions are machined at the rotating work piece proximal to the machined faces or directly adjacent thereto.

Before enveloping surfaces of the second pair of pinions can be machined in the same way, the work piece has to be pivoted back about the pivot axis and for this purpose it is clamped again in its center portion at surfaces that are typically not yet machined, the new clamping is performed after disengaging the clamping between the points, the work piece is pivoted back about the pivot axis so that the second pair of pinions is on the rotation axis and can be clamped between the points.

This way, already two of the rotation symmetrical sections are machined to a finish.

Subsequently the same process described supra is performed for the second pair of aligned rotation symmetrical sections.

According to the described method, the enveloping surfaces can be machined by turn milling or by turning.

Furthermore, machining of opposite parallel faces and centering boreholes in the faces can be performed simultaneously when two separate tool units are provided.

For clamping the work piece in the center portion at typically un-machined surfaces, the work piece is placed on a contact surface which is oriented parallel to the plane of the intersecting rotation axes of the rotation symmetrical work piece surfaces.

Advantageously, at least two, optionally also four clamping jaws that are radially oriented inward in inner corners between the rotation symmetrical portions are moved forward against the inner corners of the work piece and the work piece is thus clamped.

The method is implementable with a machine which includes an additional clamping device with a contact surface which extends parallel to the rotation axis of the machine in addition to the typical components of a turning machine, thus a bed, one or two tool units that are movable in Z-direction and in X-direction and a chuck and an opposite tailstock or an opposite chuck.

The raw part is placed onto this placement surface of the additional clamping device and clamped down and for machining the second pair of rotation symmetrical surfaces, the additional clamping device including the contact surface has to be pivotable about a pivot axis that is perpendicular to the receiving surface, typically the pivotability has to be provided over 90 degrees.

From this activated position, the additional clamping device can also be moved into a deactivated position outside of the operating range of the turning machine either in X-direction or in Y-direction.

Advantageously, this additional clamping device has an even number of clamping jaws, for example two or four of them that protrude upward from the contact surface and which are loadable with a force on a radial inside with respect to the pivot axis and thus clamp a work piece at its inner corners that is inserted between the clamping jaws.

Additionally, at least one tool unit has to include a tool that is drivable in the rotation, for example a centering drill which facilitates producing the centering boreholes and an end mill to machine the work piece to length.

The chuck and optionally also the opposite chuck shall be configured with a clamping device that has a centering point in its center and a drive device for the work piece in rotation direction, for example a face driver.

### c) Embodiments

Embodiments of the invention are subsequently described in more detail, wherein

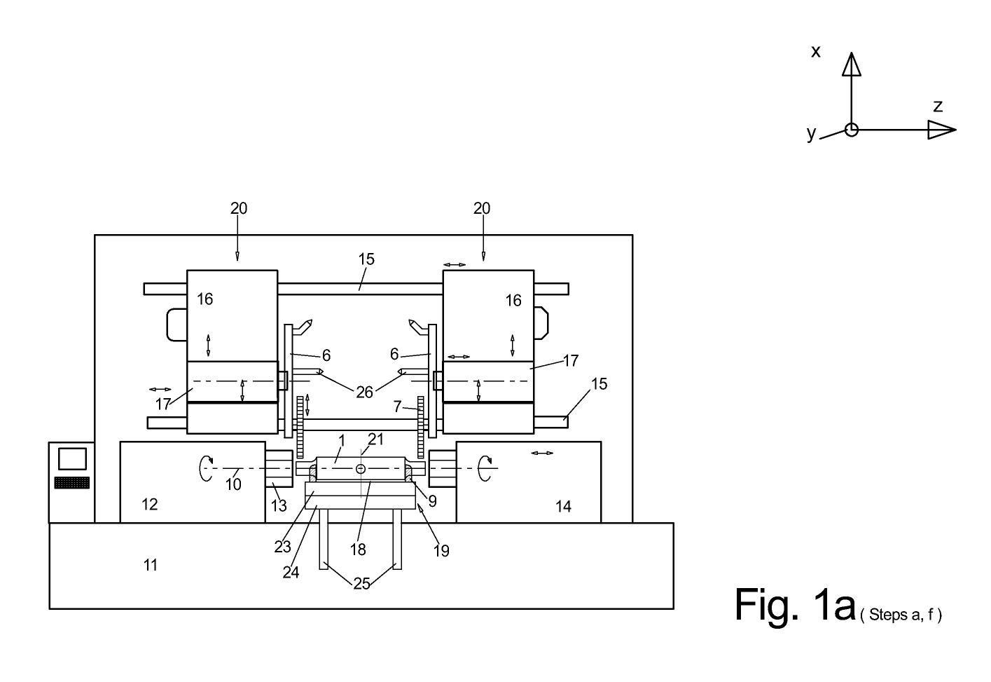

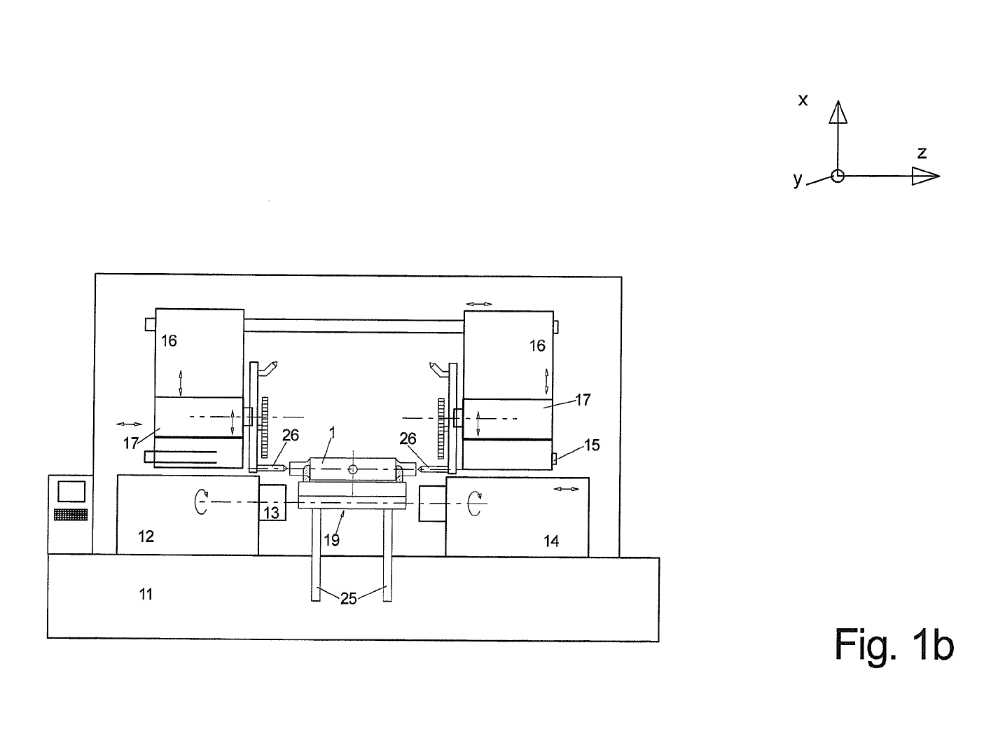

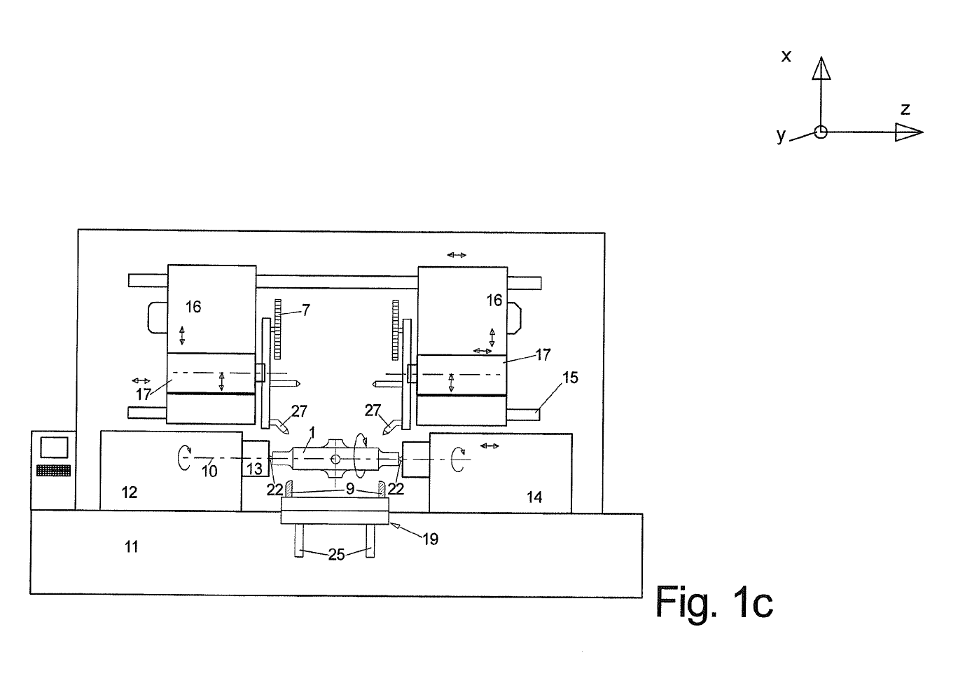

FIG. 1a-c: illustrates different operating conditions of the turning machine; and

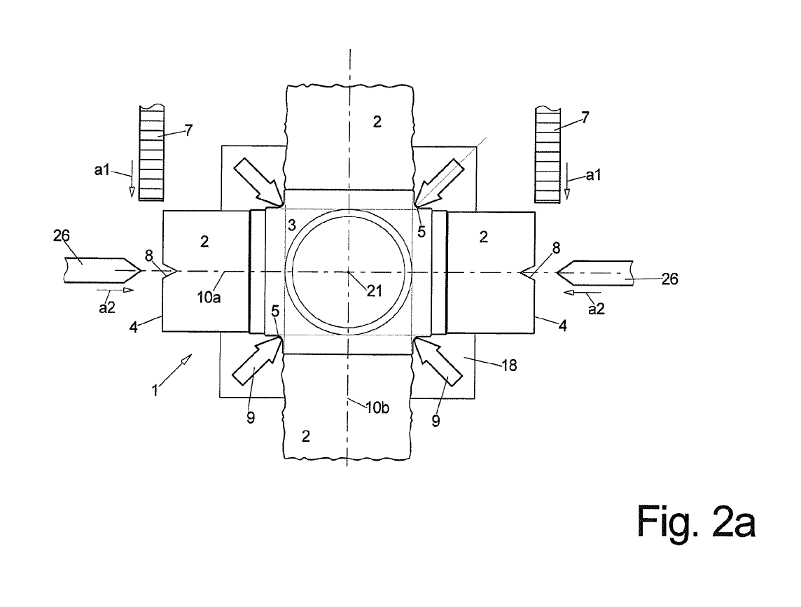

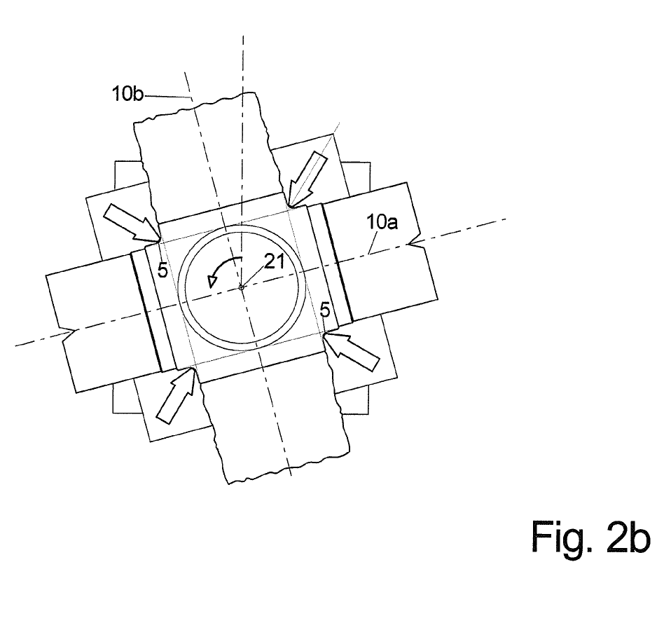

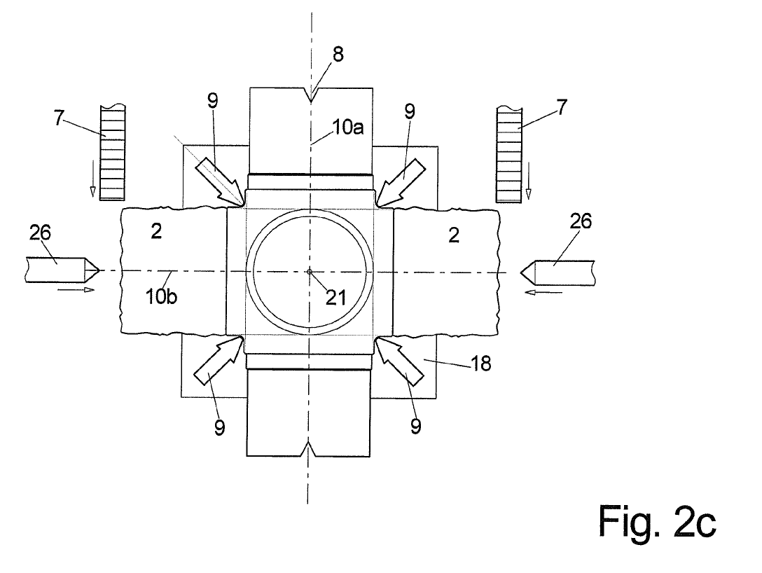

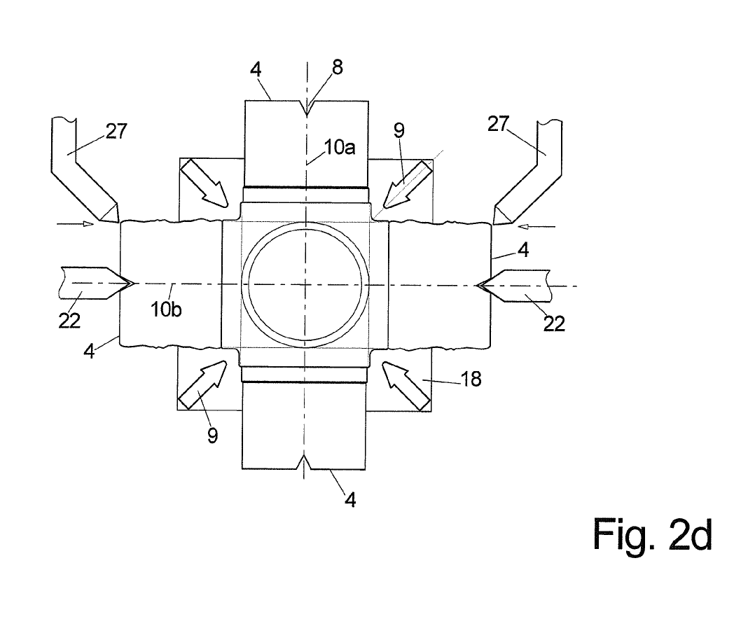

FIG. 2a-d: illustrates different machining states of the universal joint cross.

As illustrated by FIGS. 2a-d, it is the object of the invention to machine a universal joint cross with a center element 3 from which pinions 2 protrude in one plane in four directions that differ from each other by 90 degrees respectively, while the center element of the steel or cast part that is produced by master forming (casting or forging) typically remains un-machined.

The two pairs of aligned pinions that are respectively arranged opposite to one another can also be arranged with a different intermediary angle between each other.

In order to perform this machining efficiently, a specially equipped turning machine is used as illustrated in FIGS. 1a-c.

This turning machine has the typical components.

A headstock 12 is placed on a bed 11 wherein a clamping device 13 protrudes from the headstock for clamping and rotationally driving a work piece clamped therein about a rotation axis 10 which is defined as a Z-axis for the purposes of illustrating the instant invention.

An opposite headstock 14 is arranged opposite to the headstock 12 wherein the opposite headstock also carries a clamping device 13.

Two tool units 20 are arranged at the bed 11, in this case above the headstock 12 and the opposite headstock 14, wherein the tool units are advantageously configured identically and respectively include a Z-slide 16 and which are movable in Z-direction along Z-guides 15.

X-slides 17 are arranged on the Z-slides 16 wherein the X-slides are movable in X-direction and respectively carry a tool revolver 6 on their front sides oriented towards each other, wherein the tool revolver can carry tools that are driven in rotation, like e.g. a centering drill or a disc cutter as well as non-rotating tools like e.g. turning tools.

With all these tools the tool units 20 can work at a work piece 1 also simultaneously wherein the work piece is in the operating portion, in particular between the headstocks 12, 14.

The turning machine is configured special according to the invention in that a clamping device 19 for a work piece 1 is additionally arranged in the operating portion or directly under the operating portion, wherein the clamping device includes among other things a contact surface 18 advantageously arranged in the Z-Y plane for applying the universal joint cross 1 with its main plane and clamping vices 9 protruding in upward direction from this contact surface 18 wherein the clamping devices are movable against the center of the universal joint cross 1 and can clamp a center portion 3 of the universal joint cross 1 between each other as evident from FIGS. 2a-d.

The contact surface 18 is the top side of an upper table 23 which is pivotable relative to a lower table 24 arranged thereunder and providing a support function wherein the pivoting is advantageously performed about an orthogonal 21 extending in X-direction, in particular pivotable in cycles advantageously by 90 degrees.

The entire clamping device 19, advantageously including the upper table 23 and the lower table 24 is movable in X-direction along X-guides 25 into the operating portion and advantageously movable in downward direction or in upward direction and also in downward direction out of the operating portion.

Optionally the X-guides 25 for the clamping device 19 are extended in upward direction far enough so that a universal joint cross 1 resting on them is movable in upward direction beyond the operating portion, thus an aligned position with the rotation axis 10 of the turning machine in order to facilitate easier machining of the work piece by driven tools of the tool units 20.

A machine of this type facilitates a method for machining pinions 2 of the universal joint cross 1 with the following steps.

Initially (FIG. 2a) the universal joint cross 1 is inserted with its bottom side on the contact surface 18 of the clamping device 19 in a centric manner between the pulled back clamping jaws 9 that are thus moved in a radially outward direction so that crossing rotation axes 10a, b of the two pairs of pinions 2 extend parallel to the contact surface 18.

Now the clamping jars 9 are moved in radially inward direction until they contact respective inner corners 5 of the center component 3 and clamp the universal joint cross 1 firmly in a centric manner between each other. Advantageously the clamping jaws 9 are hydraulically connected with each other so that they respectively apply the same clamping pressure.

The universal joint cross 1 thus clamped is already moved up or is now being moved up by the clamping device 19 up to a level at least of the rotation axis 10 of the turning machine, optionally beyond, so that the pair of pinions 2 whose rotation axis 10a is parallel to the rotation axis 10 of the turning machine can initially be machined to length in that the faces 4 of the pinions 2 are milled to size e.g. by a disc cutter 7. The disc cutter either sits on a respective tool revolver 6 or is implemented as a separate tool unit at the turning machine.

Subsequently, the two tool revolvers 6 are rotated so that the centering drills 26 provided thereon are in alignment with the rotation axis 10a of the pair of pinions 2 (FIG. 1b) and the centering drills 26 are moved in Z-direction into the face 4 so that they produce a centering borehole 8 therein.

As soon as this is done, the upper table 23 is rotated together with the universal joint cross 1 about the orthogonal 21 relative to the lower table by 90 degrees so that the not yet machined pair of pinions is arranged with its rotation axis 10b parallel to the rotation axis 10 of the turning machine and the second pair of pinions is machined according to FIG. 2c by the same method as described supra.

Now the clamping device 19 together with the universal joint cross 1 clamped thereon is moved downward far enough so that the rotation axis 10a of the pinions 2 that are machined at their faces already is aligned with the rotation axis of the turning machine and the centering points 22 of the clamping devices 13 engage the centering boreholes 8 and thus clamp the universal joint cross 1 between the centering points 22.

As soon as this has been performed the clamping device 19 is disengaged in that the clamping jaws 9 move back in radially outward direction and release the universal joint cross 1 and the entire clamping device 19 is moved downward along the X-guides 25 far enough so that (FIG. 1c) the universal joint cross 1 can be driven in rotation about the rotation axis 10 of the turning machine by the headstock 12 and the opposite headstock 14. For this purpose typically face drivers or other elements that impart a torque about the rotation axis 10 onto the work piece are in contact with the universal joint cross outside of the centering pins 22.

In this condition the rotating enveloping surfaces of the pinions 2 which are supported by the centering pins 22 are machined through turning by the turning tools 27 of the tool revolver 6.

Subsequently the clamping device 19 moves upward until the universal joint cross 1 contacts its upper contact surface 18 again and the clamping jaws 9 are moved radially inward and forward and clamp the universal joint cross 1 in the inner corners 5 again.

As soon as this has been performed, the centering points 22 are moved back from the centering boreholes 8 and (FIG. 2b) the upper table 23 is rotated together with the universal joint cross 1 about the orthogonal 21 relative to the lower table 24 in this case by 90 degrees, preferably rotated back so that the pair of pinions that is still un-machined at its enveloping surfaces is oriented parallel to the rotation axis 10 of the turning machine with its rotation axis 10b.

The centering points 22 of the clamping devices 13 now engage the centering boreholes 8 and thus clamp the universal joint cross 1 between the centering points 22 so that according to FIG. 2d the second pair of pinions is machined with the same method as described supra, namely the rotating enveloping surfaces of the pinions 2 which are supported by the centering points 22 are machined through turning by turning tools 27 of the tool revolver 6.

Alternatively it is also possible to machine the first pair of pinions aligned with or parallel to the rotation axis of the turning machine initially supported by the additional clamping device 19 and directly thereafter supported between the points 22 and thereafter machining the second pair of pinions in the same manner after rotating the work piece by 90 degrees by the additional clamping device 19.

### REFERENCE NUMERALS AND DESIGNATIONS

1 Universal Joint Cross, Work Piece
2 Pinion
3 Center Element
4 Face
5 Inner Corner
6 Tool Revolver
7 Cutter, Disc Cutter
8 Centering Borehole
9 Clamping Jaw
10 Rotation Axis, Z-Direction
10a, b Rotation axis
11 Bed
12 Headstock
13 Clamping Chuck
14 Opposite Headstock
15 Z-Guide
16 Z-Slide
17 X-Slide
18 Contact Surface
19 Clamping Device
20 Tool Unit
21 Orthogonal
22 Centering Point
23 Upper Table
24 Lower Table
25 X-Guide
26 Centering Drill
27 Turning Tool

1. A method for machining universal joint crosses (1) with pairs of rotation symmetrical pinions (2), wherein two respective pinions (2) are in alignment with one another and rotation axes (10a, b) of the two pairs enclose an intermediary angle, the method comprising the steps:
a) clamping the work piece (1) in a center portion and machining parallel oriented faces of a first pair of pinions with rotating tools, in particular by milling (7) including introducing centering boreholes (8) into the faces,
b) rotating the work piece (1) about a perpendicular (21) that is perpendicular to a connection line between the existing centering boreholes (8) by an intermediary angle, in particular about 90°,
c) machining parallel oriented faces of the second pair of pinions with rotating tools, in particular cutters, including introducing the centering boreholes (8),
d) disengaging the current clamping and instead clamping at the two centering boreholes (8) fabricated last between centering points (22) and rotationally driving the work piece (1),
e) machining enveloping surfaces of the pinions (2) of the second pair with the work piece (1),
f) clamping the work piece (la) at the center portion (3) and disengaging the clamping between the centering points (22),
g) rotating, advantageously back rotating the work piece (1) about a perpendicular (21) by the intermediary angle, in particular by 90°, wherein the perpendicular is perpendicular to the connection lines between the provided centering boreholes (8),
h) clamping the work piece between centering points (22) in the centering boreholes fabricated last and releasing the prior clamping,
i) machining the enveloping surfaces of the pinions (2) of the first pair with the work piece rotating,
wherein the steps b) and c) can be performed first instead of the step g) as an alternative to the sequence described supra.

2. The method according to claim 1 characterized in that machining the faces that are oriented parallel to one another is performed simultaneously in steps a) and c).

3. The method according to claim 1, characterized in that the enveloping surfaces are machined by turning in steps e) and i).

4. The method according to claim 1, characterized in that the enveloping surfaces are machined simultaneously in the steps e) and i).

5. The method according to claim 1, characterized in that the work piece (1) is placed on a contact surface (18) for clamping the center portion (3), wherein the contact surface is parallel to the plane of the intersecting rotation axes (10a, b) of the rotation symmetrical pinions (2).

6. The method according to claim 1, characterized in that the work piece (1) is supported in the main plane in a form locking manner for clamping at the center portion (3) by at least four clamping jaws (9) that are oriented against the center portion (3) of the work piece (1), wherein the clamping jaws engage in particular inner corners of the center portion (3) of the work piece (1).

7. A turning machine for machining universal joint crosses (1), including two pairs of rotation symmetrical pinions (2), wherein two respective pinions (2) are aligned with each other and rotation axes (10a, b) of the two pairs enclose an intermediary angle, the turning machine comprising:
a) a bed (11).
b) at least one, in particular at least two tool units (20) that are movable on the bed in Z-direction and in X-direction,
c) a headstock (12) and an opposite tailstock or an opposite headstock (14),
d) wherein the at least one tool unit (20) includes at least one tool that can be driven in rotation,
characterized in that
e) an additional clamping device (19) for clamping a work piece with a contact surface (18) for the work piece (1), wherein the clamping device is pivotable about an orthogonal (21) to the contact surface (18) and wherein the contact surface is parallel to the rotation axis (10).

8. The turning machine according to claim 7, characterized in that the clamping device (19) is movable into the operating area of the turning machine and out of the operating area of the turning machine.

9. The turning machine according to claim 7, characterized in that the clamping device (19) includes an even number of clamping jaws (9) that are oriented against each other.

10. The turning machine according to claim 7, characterized in that the headstock (12) and/or the opposite headstock (14) respectively include a clamping device (13) with a central centering point (22).
